(19) United States
(12) Patent Application Publication
(10) Pub. No.: US 2019/0227539 A1
(43) Pub. Date: Jul. 25, 2019

(54) MOBILE DEVICE TETHERING FOR VEHICLE SYSTEMS BASED ON VARIABLE TIME-OF-FLIGHT AND DEAD RECKONING

(71) Applicant: Ford Global Technologies, LLC, Dearborn, MI (US)

(72) Inventors: Hamid M. Golgiri, Dearborn, MI (US); Aaron Matthew DeLong, Toledo, OH (US); Vivekanandh Elangovan, Canton, MI (US); Erick Michael Lavoie, Dearborn, MI (US)

(21) Appl. No.: 15/880,202

(22) Filed: Jan. 25, 2018

(51) Int. Cl. G05D 1/00; B60W 30/06; G01C 21/12; G01S 11/02

(52) U.S. Cl. CPC G05D 1/0022; B60W 30/06; G05D 1/0016; G01C 21/12; G05D 2201/0213; B60W 2400/00; B60W 2550/40; B60W 2600/00; G01S 11/026

(57) ABSTRACT

Method and apparatus are disclosed for mobile device tethering for vehicle systems based on variable time-of-flight and dead reckoning. An example vehicle includes a communication module to communicate with a mobile device using multiple frequency bands and a body control module. The body control module, at an interval, estimates a location of the mobile device relative to the vehicle using time-of-flight measurements with a first or second frequency band when the location is in a first or second zone respectively. Additionally, between the intervals, the body control module tracks the location using dead reckoning. The body control modules then controls a vehicle subsystem using the location of the mobile device.

### RELATED APPLICATIONS

This application is related to U.S. application Ser. No. ______ (Attorney Docket No. 83919418 (026780.9017)), entitled “Mobile Device Tethering for Vehicle Systems Based on Variable Time-of-Flight and Dead Reckoning,” filed on ______, which is herein incorporated by reference in its entirety.

### TECHNICAL FIELD

The present disclosure generally relates to vehicles with remotely activated systems and, more specifically, mobile device tethering for vehicle systems based on variable time-of-flight and dead reckoning.

### BACKGROUND

Increasingly, vehicles are manufactured with systems that function based on a location of a mobile device relative to the location of the vehicle. These systems may include phone-as-a-key (PaaK) or key fob based passive entry passive start (PEPS) systems, remote park assist (RePA) systems, driver welcome systems, and relay attack mitigation systems, etc. For example, a RePA system may only autonomously park the vehicle when the key fob is within 6 meters of the vehicle or the PEPS system may only prime a door to unlock when the key fob is within 2 meters of the vehicle. However, the process of tracking the key fob (sometimes referred to as “localization”) can require a relatively significant amount of battery power. Drivers are annoyed when their key fobs or mobile devices have battery issues due to passive features.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for mobile device tethering for vehicle systems based on variable time-of-flight and dead reckoning. An example vehicle includes a communication module to communicate with a mobile device using multiple frequency bands and a body control module. The body control module, at an interval, estimates a location of the mobile device relative to the vehicle using time-of-flight measurements with a first or second frequency band when the location is in a first or second zone respectively. Additionally, between the intervals, the body control module tracks the location using dead reckoning. The body control modules then controls a vehicle subsystem using the location of the mobile device.

An example method to control a remote parking assist system of a vehicle includes communicating with a mobile device via a communication module configured to use multiple frequency bands. The example method also includes defining first and second zones around the vehicle. The second zone is defined to be closer to the vehicle than the first zone. Additionally the example method includes, at an interval, estimating a location of the mobile device relative to the vehicle using time-of-flight measurements with a first frequency band when the location is in the first zone and a second frequency band when the location is in the second zone. The method includes, between the intervals, tracking the location using dead reckoning, and controlling the remote parking assist system using the location.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIGS. 1A, 1B, and 1C illustrate a vehicle operating in a first vehicle mode.

FIGS. 2A, 2B, and 2C illustrate a vehicle operating in a second vehicle mode.

FIG. 3 is a block diagram of electronic components of the vehicle of FIGS. 1A, 1B, 1C and 2A, 2B, 2C.

FIG. 4 is a flowchart of a method to control the vehicle of FIGS. 1A, 1B, 1C and 2A, 2B, 2C using localization based on variable time-of-flight and dead reckoning, which may be implemented by the electronic components of FIG. 3.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Several vehicles systems operate based on using a location of a mobile device (e.g., smart phone, smart watch, key fob, etc.) as a proxy for a location of a vehicle operator. These vehicle systems activate different features based on the location of the operator. These vehicle systems include passive entry passive start (PEPS) systems, remote park assist (RePA) systems, driver welcome systems, and/or relay attack mitigation systems, etc. PEPS systems facilitate keyless entry and keyless ignition of the vehicle. The PEPS system (a) primes doors of the vehicle to unlock (e.g., prepares to unlock the door in response to detecting the operator touching the door handle, etc.) when the operator crosses a threshold distance (e.g., 2 meters, etc.) associated with keyless entry and (b) activates keyless ignition (e.g., via a push button start, etc.) when the operator is inside the vehicle. RePA systems autonomously park the vehicle into a parking space when the operator is within a threshold distance of the vehicle (e.g., 6 meters, etc.). Driver welcome systems prepare a cabin of the vehicle for the operator when the operator crosses into a threshold distance of the vehicle (e.g., 4 meters, etc.). For example, the driver welcome system may illuminate cabin lights and/or adjust positions of seats, steering columns, and/or pedals, etc.

As discussed below, a vehicle performs localization on a mobile device using frequency variant time-of-flight measurements supplemented with dead reckoning. Time-of-flight (ToF) is a localization technique that determines a location of a first wireless device (e.g., the mobile device) based on a transit time of a signal between the first wireless device and a second wireless device (e.g., the vehicle). The vehicle sends a request (REQ) signal and measures a time to receive an acknowledgement (ACK) signal from the mobile device. The accuracy of the ToF measurement is based on the frequency of the REQ and ACK signals. Higher frequencies, which tend to have higher signal bandwidth, produce more accurate measurements than lower frequencies, which tend to have low signal bandwidth. However, higher frequencies require more power to operate at longer distances. Dead reckoning is a technique that uses measurements of inertial sensors (e.g., accelerometers, gyroscopes, etc.) in the mobile device to determine the current location of the mobile device based on an initial location (sometimes referred to as a “fix”). As the mobile device moves, the vehicle tracks the movement by tracking the distance and direction the mobile device has traveled relative to the initial location. However, as the mobile device moves, more and more inaccuracy is introduced into the measurement. From time-to-time, the vehicle reestablishes the fix.

As described herein, the vehicle establishes a fix of the mobile device using ToF. Because of the error in the measurement, the vehicle determines a zone of probability that encompasses the possible locations of the mobile device taking into account the measurement error. The mobile device and the vehicle are configured with multiple wireless controllers (e.g., radios, antennas, etc.) to communicate using multiple discrete frequency bands. The frequency of the ToF signals is based on the location of the mobile device in relation to the vehicle. Generally, as the mobile device moves closer to the vehicle, the precision of tracking the mobile device increases and, as the mobile device move farther away from the vehicle, the precision of tracking the mobile device decreases. In some examples, the vehicle establishes multiple proximity zones around the vehicle based on distance thresholds. When the zone of probability crosses into a proximity zone, the vehicle changes which frequency band it uses for the ToF signals. As the mobile device (e.g., the associated zone of probability) crosses into proximity zones and becomes closer to the vehicle, the vehicle uses the frequency bands that have a higher center frequency. Conversely, as the mobile device (e.g., the associated zone of probability) crosses into proximity zones and becomes farther from the vehicle, the vehicle uses the frequency bands that have a lower center frequency. In some examples, the vehicle selects from a 2.4 gigahertz (GHz) band, a 5.0 GHz bands, and a 60.0 GHz band. For example, the vehicle may use the 2.4 GHz band when the zone of probability associated with the mobile device is greater than 6 meters from the vehicle, the 5.0 GHz band when the zone of probability associated with the mobile device is between 6 meters and 2 meters from the vehicle, and 60.0 GHz bands when the zone of probability associated with the mobile device is less than 2 meters from the vehicle. As a result, because frequencies with larger available bandwidths produce more accurate ToF measurements, the zone of probability shrinks as the mobile device moves closer to the vehicle. In some examples, the vehicle selects the locations of the proximity zones and the frequency bands associated with the proximity zones as a function of the modes (e.g., RePA, PEPS, etc.) that the vehicle is currently operating. For example, when the RePA system, but not the PEPS system, is engaged, the proximity zones and the associated frequency bands may be changes to prioritize power savings over accuracy. That is, in such examples, there may be fewer proximity zones with lower frequency bands used in those proximity zones. Additionally, in some examples, the highest precision frequency band is used to determine whether the mobile device is inside or outside localization.

In some examples, the interval at which the vehicle establishes the fix using ToF measurements is based on which proximity zone that the zone of probability associated with the mobile is in. For example, when the zone of probability associated with the mobile is greater than 6 meters, the vehicle may send ToF signals to obtain a fix on the vehicle every 30 seconds. Between fixes, the vehicle uses dead reckoning to track the location of the zone of probability of the mobile device. To use dead reckoning, the vehicle receives measurements from the inertial sensor(s) of the mobile device. In some examples, the frequency band used to communicate the measurements from the inertial sensor can be different from the frequency band used for the ToF measurement. For example, because of the location of the zone of probability is within 2 meters of the vehicle, the vehicle may use the 60.0 GHz frequency band for the ToF measurement and use Bluetooth® (e.g., on the 2.4 GHz band) to communicate with the inertial sensor measurements regardless of the distance between the mobile device and the vehicle. In such a manner, the vehicle can track the location of the mobile device to an acceptable degree of accuracy while conserving power of the mobile device.

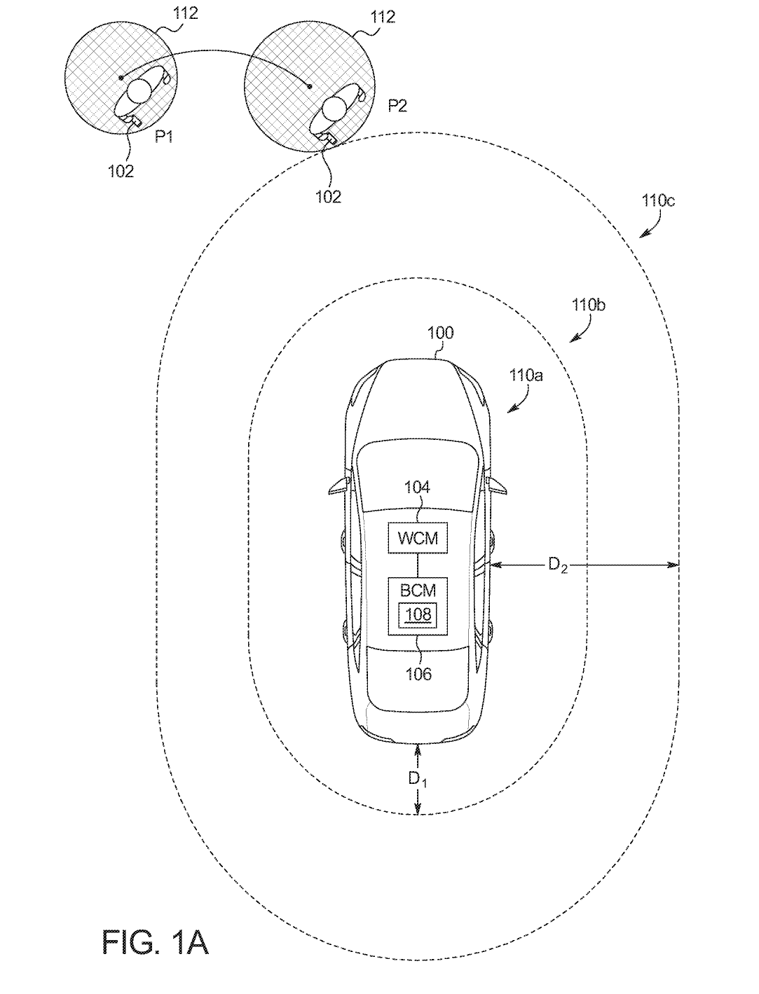

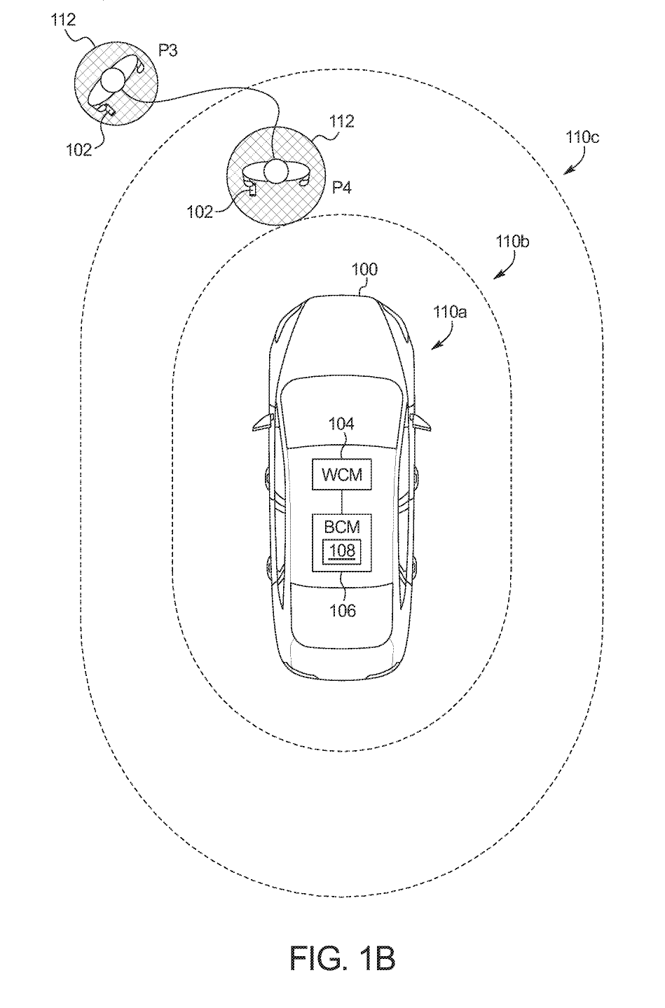

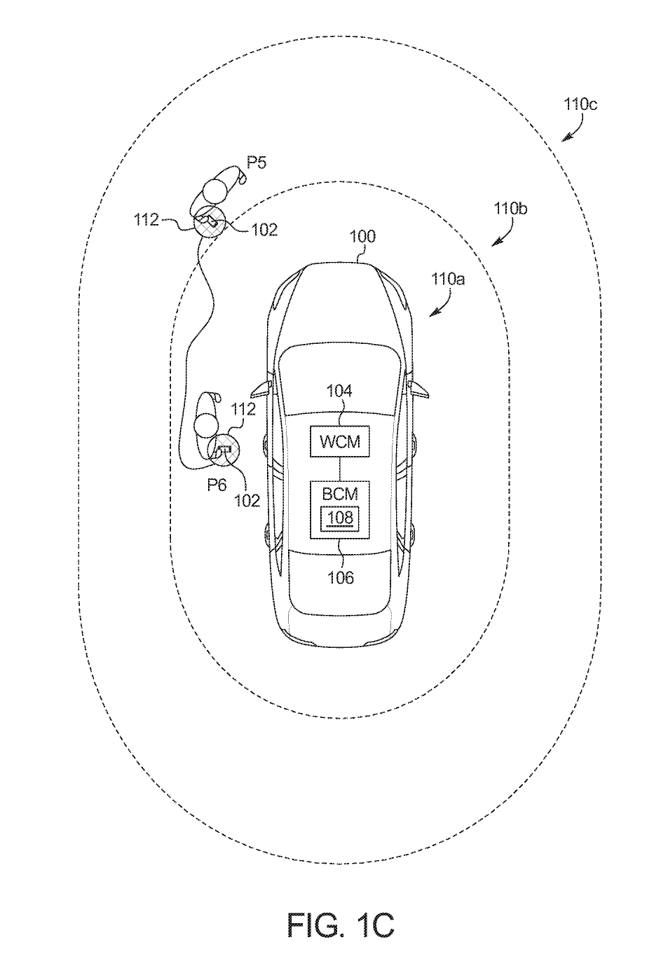

FIGS. 1A, 1B, and 1C illustrate a vehicle 100 and a mobile device 102 operating in accordance with the teachings of this disclosure. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated examples, the vehicle 100 includes a wireless control module (WCM) 104 and a body control module 106. In some examples, the vehicle 100 also includes an autonomy unit (not shown) that controls the RePA system and other autonomous features (e.g., such as autopilot, adaptive cruise control, lane keep assist, etc.).

The wireless control module 104 includes multiple communication controllers that include hardware (e.g., processors, memory, storage, antenna, etc.) and software to communicate over different discrete bands. In some examples, the wireless control module 104 includes communication controllers to communicate over the 2.4 GHz frequency band, the 5.0 GHz frequency band, and the 60.0 GHz frequency band. The communications controllers operate different standard-based networks. For example, the communication controller for the 2.4 GHz frequency band may use the Bluetooth®, Bluetooth® Low Energy, Zigbee®, and/or one of the Wi-Fi® protocols (e.g., IEEE 802.11b, 802.11g, and/or 802.11n, etc), the communication controller for the 5.0 GHz frequency band may use one of the Wi-Fi® protocols (e.g., IEEE 802.11n and/or 802.11ac, etc.), and the communication controller for the 60.0 GHz frequency band may use one of the Wi-Fi® protocols (e.g., IEEE 802.11ad) or WirelessHD (the WirelessHD Specification Version 1.1 as subsequently amended, maintained by the WirelessHD Consortium). In some examples, one of the communication controllers communicated using more than one frequency band. For example, a communication controller implementing the IEEE 802.11n Wi-Fi® protocol may be able to communicate using the 2.4 GHz frequency band and the 5.0 GHz frequency band. In some examples, the wireless control module 104 includes other communication controllers that operate at other frequencies bands. For example, the wireless control module 104 may include a communication controller that operates at the 900 megahertz frequency band. In such an example, the communication controller may implement the Z-Wave® protocol.

The body control module 106 controls various subsystems of the vehicle 100. For example, the body control module 106 may control power windows, power locks, an immobilizer system, and/or power mirrors, etc. The body control module 106 is coupled to circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc. In some examples, the body control module 106 includes the PEPS system. The PEPS system (a) unlocks a door when a hand of a person is detected (e.g., via a touch sensor, via an infrared sensor, etc.) on or proximate the handle of the door when the mobile device is within a threshold distance (e.g., 2 meters, etc.) of the vehicle 100, and/or (b) disengages the immobilizer and starts the engine without a key in an ignition (e.g., by pressing an ignition button, etc.) when the mobile device 102 is inside the vehicle 100. In some examples, the PEPS system also includes a welcome mode that illuminates lights inside and outside the cabin of the vehicle 100 and/or changes settings of various systems within the cabin (e.g., the position and/or angle of the driver's seat, the position and/or angle of the steering column, the position of the pedals, radio presets, etc) when the mobile device 102 is within a different threshold distance (e.g., 3 meters, etc.) of the vehicle 100.

In the illustrated examples, the body control module 106 includes a device tracker 108. The device tracker 108 estimates the location of the mobile device 102 and provides that location to other systems of the vehicle 100 (such as the PEPS system and the RePA system, etc.). In the illustrated examples of FIGS. 1A, 1B, and 1C, the device tracker 108 establishes proximity zones 110a, 110b, and 110c. The device tracker 108 defines the proximity zones 110a, 110b, and 110c. In the illustrated examples, a first proximity zone 110a is defined as an area between the vehicle 100 and a first distance (D1), a second proximity zone 110b is defined as an area between first distance (D1) and a second distance (D2) from the vehicle 100, and a third proximity zone 110c is defined as an area farther than the second distance (D2) from the vehicle 100 In some examples, the distances (D1, D2) used to define the proximity zones 110a, 110b, and 110c are related to the distance thresholds for the various systems (e.g., the PEPS system, the RePA system, etc.) of the vehicle 100. For example, the first distance (D1) may be 2 meters corresponding with the threshold of the passive entry feature of the PEPS system and the second distance may be 6 meters corresponding with the threshold used by the RePA system. However, the distances (D1, D2) used to define the proximity zones 110a, 110b, and 110c may not correspond to the thresholds of the any of the systems of the vehicle 100. That is, the determination of whether the mobile device 102 is within a threshold distance of the vehicle 100 to activate a particular feature may be separate from the determination of which of the proximity zones 110a, 110b, and 110c the mobile device 102 is in.

To track the location of the mobile device 102, the device tracker 108 uses time-of-flight (ToF) measurements supplemented with dead reckoning. The device tracker 108 uses ToF measurements to acquire a fix on the location of the mobile device 102 from time-to-time and uses dead reckoning to track the location of the mobile device 102 between fixes. To perform a ToF measurement, the device tracker 108 sends, via the wireless control module 104, a request message (REQ) to the mobile device 102 and measures the time it takes to receive a corresponding acknowledgement message (ACK) from the mobile device 102. To send the REQ message, the device tracker 108 selects a frequency band to communicate with the mobile device based on which of the proximity zones 110a, 110b, and 110c that the mobile device 102 is estimated to be in. Generally, when the mobile device 102 is closer to the vehicle 100, the device tracker 108 selects a higher frequency band. In some examples, when the mobile device 102 is in the third proximity zone 110c, the device tracker 108 selects the 2.4 GHz frequency band. In some examples, when the mobile device 102 is in the second proximity zone 110b, the device tracker 108 selects the 5.0 GHz frequency band. Additionally, in some examples, when the mobile device 102 is in the first proximity zone 110a, the device tracker 108 selects the 60.0 GHz frequency band.

Alternatively, in some examples, the device tracker 108 assigns one frequency band to the outer most proximity zone 110c and the inner most proximity zone 110a and a different, more accurate, frequency band to the middle proximity zone 100b. For example, the device tracker 108 may want to determine with heightened accuracy when the mobile device 102 transitions from the middle proximity zone 110b to the outer most proximity zone 110c, but may be robust enough to tolerate greater inaccuracy when the mobile device 102 is in the outer most proximity zone 110c or the inner most proximity zone 110a. As such an example, when the RePA system is active, the device tracker 108 may establish the boundaries of the proximity zones 110a, 110b, and 110c such that the middle proximity zone 110b encompasses the area 5.5 meters to 6.0 meters from the vehicle 100 so that the device tracker 108 tracks with greater accuracy when the mobile device 102 is farther than 6.0 meters from the vehicle. In some examples, the device tracker 108 assigns a lower frequency band (e.g., 2.4 GHz or 5.0 GHz, etc.) to the outer most proximity zone 110c and the inner most proximity zone 110a and a higher frequency band (e.g., 5.0 GHz or 60.0 GHz, etc.) to the middle proximity zone 110b. Alternatively in some examples, the outer most proximity zone 110c and the inner most proximity zone 110a may not be assigned the same frequency. For example, the outer most proximity zone 110c may be assigned the 2.4 GHz frequency band, the middle proximity zone 110b may be assigned the 60.0 GHz frequency band, and the inner most proximity zone 110a may be assigned the 5.0 GHz frequency band.

In some examples, the mobile device 102 sends a message to the device tracker 108 indicating which function of the vehicle 100 (e.g., RePA, PEPS, etc.) is to be active. For example, the operator may press a button or select an interface on the mobile device 102 to switch between activating the PEPS system and activating the RePA system. In such examples, the device tracker 108 configures the proximity zones 110a, 110b, and 110c (e.g., changes the number of the proximity zones 110a, 110b, and 110c and/or the boundaries of the proximity zones 110a, 110b, and 110c, etc.) and the frequency bands assigned to the proximity zones 110a, 110b, and 110c in response to receiving the message from the mobile device. For example, in the PEPS mode, the device tracker 108 may (a) configure the boundaries of the proximity zones 110a, 110b, and 110c to correspond to the thresholds for the PEPS system, and (b) assign the frequency bands so that the outer most proximity zone 110c is associated with the lowest used frequency band and the inner most proximity zone 110a is associated with the highest used frequency band. As another example, in the RePA mode, the the device tracker 108 may (a) configure the boundaries of the proximity zones 110a, 110b, and 110c to correspond to the thresholds for the RePA system, and (b) assign the frequency bands so that the middle proximity zone 110b is associated with the highest used frequency band, while the outer most and the inner most proximity zones 110a and 110c are associated with lower frequency bands.

In some examples, the interval at which the device tracker 108 uses ToF measurements to acquire a fix on the location of the mobile device 102 is based on which proximity zone 110a, 110b, and 110c that the mobile device 102 is in. Generally, in such examples, the device tracker 108 establishes the interval to be more frequent the closer the mobile device 102 is to the vehicle 100. For example, when the mobile device 102 is in the third proximity zone 110c, the device tracker 108 may acquire a fix on the mobile device 102 using ToF measurements every 30 seconds. In some examples, the device tracker 108 establishes the interval based on which of the subsystem of the vehicle 100 are activated. For examples, the intervals may be different depending on whether the RePA system is activate and/or the PEPS system is activates. As such an example, when the RePA system is active, the intervals may be shorter than when just the PEPS system is active. Alternatively or additionally, in some examples, the interval at which the device tracker 108 uses ToF measurements to acquire a fix on the location of the mobile device 102 is based on the relative speed and/or trajectory of the mobile device with reference to the vehicle 100. For example, the device tracker 108 may acquire a fix of the mobile device 102 more frequently when the mobile device 102 is traveling quickly towards the vehicle 100. Alternatively in some examples, the device tracker 108 establishes the interval based on how close the mobile device 102 is to the outer boundaries of the proximity zones 110a, 110b, and 110c. For example, when the RePA system is active, the device tracker 108 make the interval shorter when as the mobile device 102 approaches the outer boundary of the outer most proximity zone 110c.

Because ToF measurements inherently have error, after acquiring a fix of the mobile device 102, the device tracker 108 determines a zone of probability 112 that represents an area that contains the location of the mobile device 102 taking into account the error in the estimation. That is, instead of representing a single location, the zone of probability represents a set of possible locations of the mobile device 102 based on the error in the ToF measurement. Because the different frequency bands have different amounts of error because of the differences in the available bandwidth, the zone of probability 112 is smaller the higher the frequency used to take the ToF measurement. Table (1) below shows example error rates associated with example frequency bands.

TABLE (1)
Example Error Rates for ToF Measurements

| Frequency Band | Worst Cast ToF Error |
|---|---|
| 2.4 GHz | 3 meters |
| 5.0 GHz | 1 meter |
| 60.0 GHz | 5 centimeters |

As shown in Table (1) above, using the 2.4 GHz frequency band, for example, the actual location of the mobile device 102 may be 3 meters from the estimated location. The device tracker 108 switches the frequency band when the edge of the zone of probability 112 closest to the vehicle 100 crosses into a different one of the proximity zones 110a, 110b, and 110c. As a result, as the mobile device 102 approaches the vehicle 100, the zone of probability 112 associated with the mobile device 102 becomes smaller.

In some examples, to switch frequency bands, the device tracker 108 sends a frequency change message (FREQ) to the mobile device 102 at the current frequency that indicates which frequency band the device tracker 108 will switch to. For example, if the device tracker 108 is going to switch the ToF measurement from the 2.4 GHz frequency band to the 5.0 GHz frequency band, the device tracker 108 may send the FREQ message at the 2.4 GHz frequency band. Alternatively, in some examples, the mobile device 102 monitors all of the possible frequency bands and sends an ACK message on the same frequency band that the REQ message was received from. For example, the mobile device 102 may monitor the 2.4 GHz, 5.0 GHz, and the 60.0 GHz frequency bands. In such an example, when the REQ message is received on the 5.0 GHz frequency band, the mobile device 102 may return the ACK message on the 5.0 GHz frequency band.

Between acquiring fixes using ToF measurements, the device tracker 108 uses dead reckoning to track the location of the zone of probability 112 associated with the mobile device 102. To perform dead reckoning, the device tracker 108 receives measurements from one or more inertial sensors (e.g., accelerometer, gyroscope, etc.). Using the speed and trajectory of the mobile device 102 as indicated by the measurements from the inertial sensors, the device tracker 108 tracks the location of the mobile device 102. In some examples, the device tracker 108 uses the center of the zone of probability 112 as the location that is being track via dead reckoning. Because dead reckoning also introduces error in location, the zone of probability 112 may become larger between fixes to account for this error.

FIGS. 1A, 1B, and 1C illustrate an example of the device tracker 108 tracking the mobile device 102 by varying the frequencies at which the ToF measurement is taken. While FIGS. 1A, 1B, and 1C illustrate the mobile device 102 approaching the vehicle 100 and the frequencies bands being used increasing in frequency as a result, the opposite also occurs. That is, as the mobile device 102 moves away from the vehicle 100, the frequencies bands (and thus the precision of tracking the mobile device 102) decrease in a similar manner. In the illustrated examples, the first distance (D1) may be 2.0 meters and the second distance (D2) may be 3.0 meters. In the illustrated example of FIG. 1A, the zone of probability 112 starts at position P1, which is in the third proximity zone 110c. In the third proximity zone 110c, the device tracker 108 uses the 2.4 GHz frequency band to acquire the fix on the mobile device 102. The device tracker 108 tracks the location of the zone of probability 112 using dead reckoning to position P2. At position P2, the edge of the zone of probability 112 intersects the boundary of the second proximity zone 110b. In the illustrated example of FIG. 1B, because the device tracker 108 switches to the 5.0 GHz frequency band, the device tracker 108 determines that the smaller zone of probability 112 is at position P3. The device tracker 108 tracks the location of the zone of probability 112 to position P4, wherein the edge of the zone of probability 112 intersects the boundary of the first proximity zone 110a. In FIG. 1C, the device tracker 108 switches to the 60.0 GHz frequency band. The device tracker 108 generates a smaller zone of probability 112 at this frequency band. The device tracker 108 uses dead reckoning to track the zone of probability 112 from position P5 to position P6.

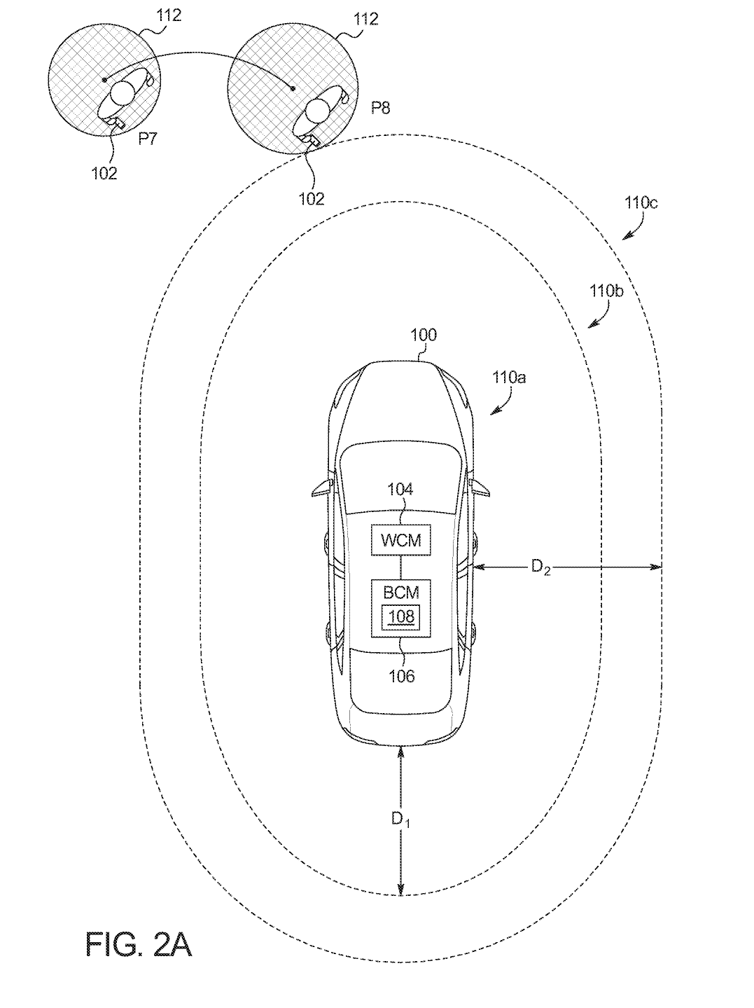

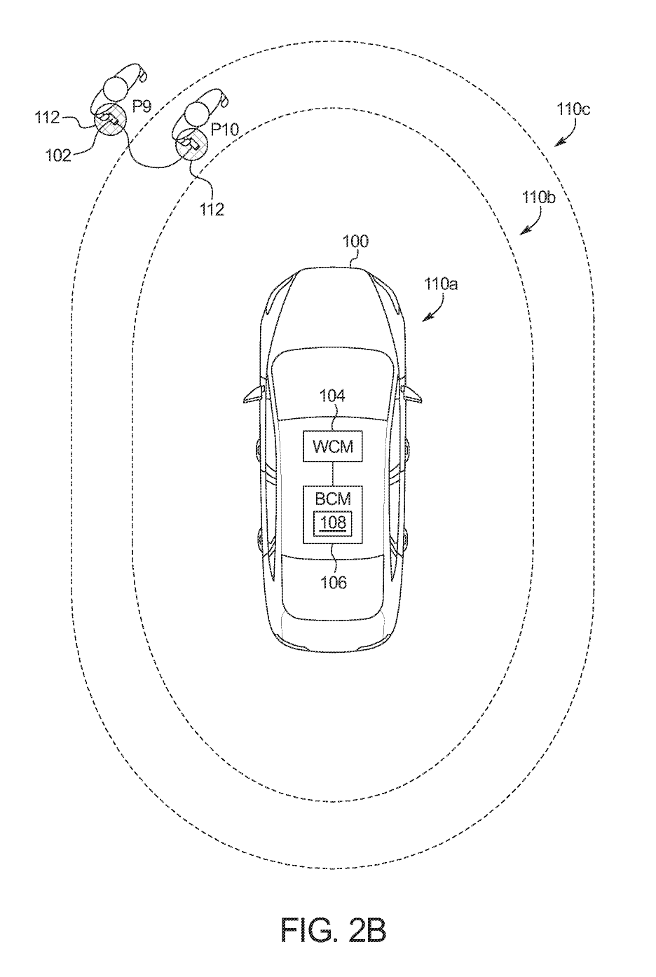

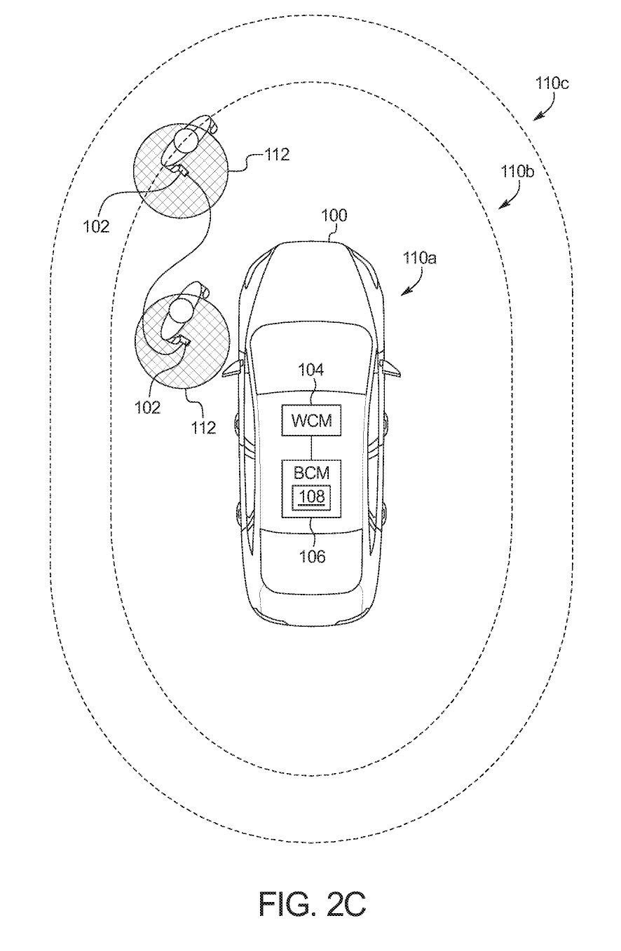

FIGS. 2A, 2B, and 2C illustrate an example of the device tracker 108 tracking the mobile device 102 by varying the frequencies at which the ToF measurement is taken. While FIGS. 2A, 2B, and 2C illustrate the mobile device 102 approaching the vehicle 100 and the frequencies bands being used increasing in frequency as a result, the opposite also occurs. That is, as the mobile device 102 moves away from the vehicle 100, the frequencies bands (and thus the precision of tracking the mobile device 102) change in a similar manner. In the illustrated examples, the first distance (D1) may be 5.5 meters and the second distance (D2) may be 6.0 meters. In the illustrated example of FIG. 2A, the zone of probability 112 starts at position P7, which is in the third proximity zone 110c. In the third proximity zone 110c, the device tracker 108 uses the 2.4 GHz frequency band to acquire the fix on the mobile device 102. The device tracker 108 tracks the location of the zone of probability 112 using dead reckoning to position P8. At position P8, the edge of the zone of probability 112 intersects the boundary of the second proximity zone 110b. In the illustrated example of FIG. 2B, because the device tracker 108 switches to the 60.0 GHz frequency band, the device tracker 108 determines that the smaller zone of probability 112 is at position P9. The device tracker 108 tracks the location of the zone of probability 112 to position P10, wherein the edge of the zone of probability 112 intersects the boundary of the first proximity zone 110a. In FIG. 2C, the device tracker 108 switches to the 5.0 GHz frequency band. The device tracker 108 generates a larger zone of probability 112 at this frequency band. The device tracker 108 uses dead reckoning to track the zone of probability 112 from position P11 to position P12.

FIG. 2 is a block diagram of electronic components 300 of the vehicle 100 of FIGS. 1A, 1B, and 1C. In the illustrated example, the electronic components includes the wireless control module 104, the body control module 106, and a vehicle data bus 302.

The body control module 106 includes a processor or controller 304 and memory 306. In the illustrated example, the body control module 106 is structured to include device tracker 108. Alternatively, in some examples, the device tracker 108 may be incorporated into another electronic control unit (ECU) (such as the wireless control module 104 or the autonomy unit, etc.) with its own processor and memory. The processor or controller 304 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 306 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory 306 includes multiple kinds of memory, particularly volatile memory and non-volatile memory.

The memory 306 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 306, the computer readable medium, and/or within the processor 304 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

The vehicle data bus 302 communicatively couples the wireless control module 104 and the body control module 106. In some examples, the vehicle data bus 302 includes one or more data buses. The vehicle data bus 302 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

In the illustrated example, the mobile device 102 includes inertial sensors 308 and multiple communication controllers 310. The inertial sensors 308 are devices that sense movement of the mobile device 102 to determine speed and trajectory of the mobile device 102. The inertial sensor 308 may, for example, be accelerometers and/or gyroscopes, etc. The communication controllers 310 communicate using the frequencies and the protocols of the wireless control module 104 of the vehicle 100. For example, the communication controllers 310 may communicate over the 2.4 GHz frequency band, the 5.0 GHz frequency band, and the 60.0 GHz frequencies band to facilitate communication (e.g., sending measurements from the inertial sensors 308) with the vehicle 100 and ToF measurements by the vehicle 100. For example, in response to receiving a request message (REQ) from the vehicle 100 at a certain frequency band, the communication controller 310 may return an acknowledge message (ACK) to the vehicle 100 at that frequency band.

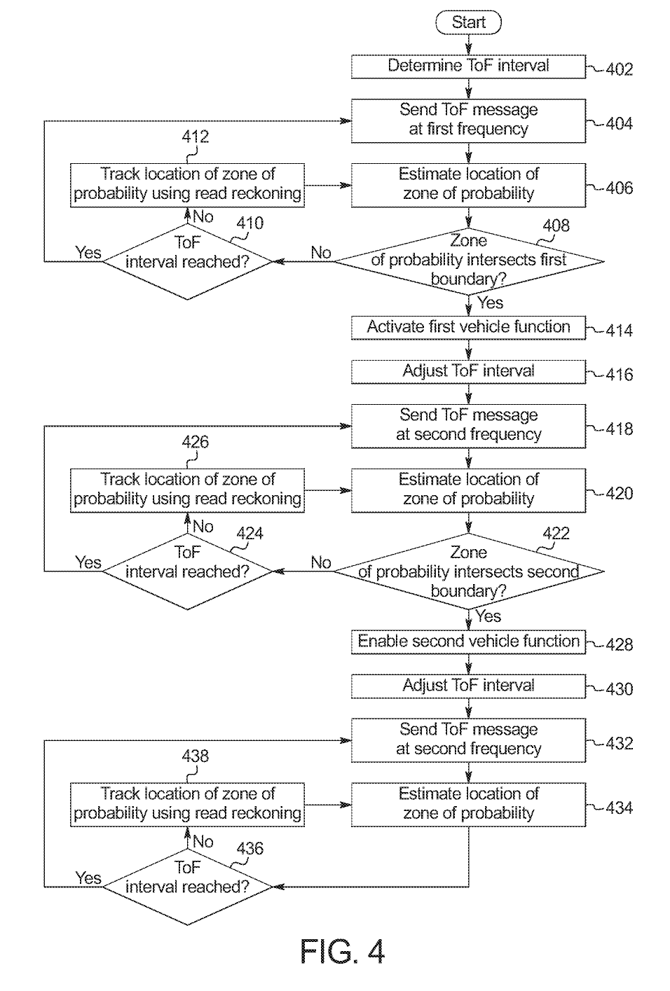

FIG. 4 is a flowchart of a method to control the vehicle 100 of FIGS. 1A, 1B, and 1C using localization based on variable time-of-flight and dead reckoning, which may be implemented by the electronic components 300 of FIG. 2. Initially, at block 402, the device tracker 108 determines a polling interval to the ToF measurements. In some examples, the interval is a default value (e.g., every 100 milliseconds, etc.). Alternatively, in some examples, the interval is based on a previous location relative to the vehicle 100 at which the mobile device 102 was measured. For example, when the last location measurement outside of the vehicle 100, the device tracker 108 may determine a first period (e.g., 100 milliseconds, etc.) and when the last location measurement was inside the vehicle 100, the device tracker 108 may determine may have a second period (e.g., every 10 milliseconds, etc.). That is, when the last location measurement was inside the vehicle 100, the device tracker 108 may assume that the mobile device 102 has recently exited the vehicle 100 and is thus close to the vehicle 100.

At block 404, the device tracker 108 sends the ToF message using a first frequency band. In some examples, the first frequency band is the 2.4 GHz frequency band. At block 406, the device tracker 108 estimates the location of the zone of probability 112 relative to the location of the vehicle 100. At block 408, the device tracker 108 determines whether the zone of probability 112 intersects a boundary between a third proximity zone 110c and a second proximity zone 110b. When the zone of probability 112 intersects the boundary, the method continues at block 414. Otherwise, when the zone of probability 112 does not intersect the boundary, the method continues at block 410. At block 410, the device tracker determines whether the polling interval has been reached. If the polling interval has been reached, the method returns to block 404. Otherwise, when the polling interval has not been reached, the method continues at block 412. At block 412, the device tracker 108 tracks the mobile device 102 using dead reckoning based on inertial sensor measurement data received from the mobile device 102.

At block 414, the device tracker 108 activates and/or enables a vehicle function. For example, the device tracker 108 may enable the RePA system to autonomously control the vehicle 100. At block 416, the device tracker 108 adjusts the polling interval. In some examples, the device tracker 108 sets the polling interval to be more frequent. At block 418, the device tracker 108 sends the ToF message using a second frequency band. In some examples, the second frequency band is the 5.0 GHz frequency band. At block 420, the device tracker 108 estimates the location of the zone of probability 112 relative to the location of the vehicle 100. At block 422, the device tracker 108 determines whether the zone of probability 112 intersects a boundary between the second proximity zone 110b and a first proximity zone 110a. When the zone of probability 112 intersects the boundary, the method continues at block 428. Otherwise, when the zone of probability 112 does not intersect the boundary, the method continues at block 424. At block 424, the device tracker determines whether the polling interval has been reached. If the polling interval has been reached, the method returns to block 418. Otherwise, when the polling interval has not been reached, the method continues at block 426. At block 426, the device tracker 108 tracks the mobile device 102 using dead reckoning based on inertial sensor measurement data received from the mobile device 102.

At block 428, the device tracker 108 activates and/or enables a vehicle function. For example, the device tracker 108 may prime one or more of the doors to unlock when a user is detected proximate a handle of the vehicle 100. At block 430, the device tracker 108 adjusts the polling interval. In some examples, the device tracker 108 sets the polling interval to be more frequent. At block 432, the device tracker 108 sends the ToF message using a third frequency band. In some examples, the third frequency band is the 60.0 GHz frequency band. At block 434, the device tracker 108 estimates the location of the zone of probability 112 relative to the location of the vehicle 100. At block 436, the device tracker determines whether the polling interval has been reached. If the polling interval has been reached, the method returns to block 432. Otherwise, when the polling interval has not been reached, the method continues at block 438. At block 438, the device tracker 108 tracks the mobile device 102 using dead reckoning based on inertial sensor measurement data received from the mobile device 102.

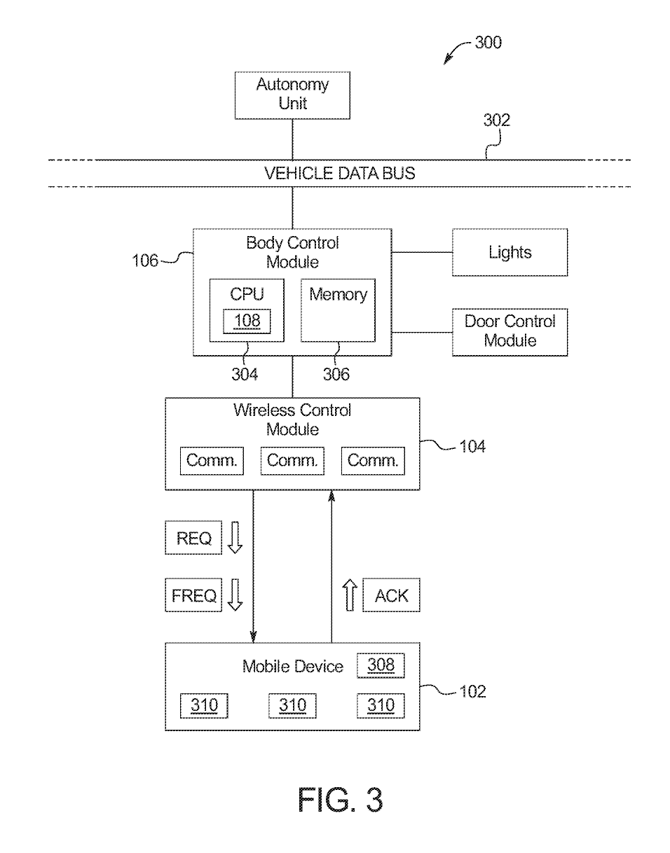

The flowchart of FIG. 3 is representative of machine readable instructions stored in memory (such as the memory 306 of FIG. 2) that comprise one or more programs that, when executed by a processor (such as the processor 304 of FIG. 2), cause the vehicle 100 to implement the example device tracker 108 of FIGS. 1 and 2. Further, although the example program(s) is/are described with reference to the flowchart illustrated in FIG. 3, many other methods of implementing the example device tracker 108 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. As used here, the terms “module” and “unit” refer to hardware with circuitry to provide communication, control and/or monitoring capabilities, often in conjunction with sensors. “Modules” and “units” may also include firmware that executes on the circuitry. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a communication module to communicate with a mobile device using multiple frequency bands; and
a body control module to:
at an interval, estimate a location of the mobile device relative to the vehicle using time-of-flight measurements with a first or second frequency band when the location is in a first or second zone respectively;
between the intervals, track the location using dead reckoning; and
control a vehicle subsystem using the location.

2. The vehicle of claim 1, wherein the second frequency band includes a higher set of frequencies than the first frequency band.

3. The vehicle of claim 1, wherein the first and second zones are defined around the vehicle, the second zone being closer to the vehicle, and a boundary between the first zone and the second zone being at a threshold distance from the vehicle.

4. The vehicle of claim 1, wherein the body control module is to define the first zone, the second zone, and a third zone around the vehicle, the third zone being closer to the vehicle than the second zone, and the second proximity zone being closer to the vehicle than the first zone.

5. The vehicle of claim 4, wherein the body control module is to, at the interval, when the location is in the third zone, estimate the location of the mobile device based on the time-of-flight measurements using a third frequency band.

6. The vehicle of claim 5, wherein the second frequency band includes a higher set of frequencies than the first frequency band.

7. The vehicle of claim 5, wherein the second frequency band includes a higher set of frequencies than the first and third frequency bands.

8. The vehicle of claim 5, wherein:
second frequency band includes a higher set of frequencies than the first and third frequency bands; and
the third frequency band includes a higher set of frequencies than the first frequency band.

9. The vehicle of claim 4, wherein the body control module is to, at the interval:
estimate the location of the mobile device relative to the vehicle using time-of-flight measurements with the first frequency band when the location is in the first zone;
estimate the location of the mobile device relative to the vehicle using time-of-flight measurements with the second frequency band when the location is in the second zone; and
estimate the location of the mobile device relative to the vehicle using time-of-flight measurements with the third frequency band when the location is in the third zone.

10. The vehicle of claim 9, wherein the second frequency band includes a higher set of frequencies than the first and third frequency bands.

11. The vehicle of claim 10, wherein the first, second, and third frequency bands are selected from a group of 900 MHz, 2.4 GHz, 5.0 GHz, and 60.0 GHz.

12. A method to control a remote parking assist system of a vehicle, the method comprising:
communicating with a mobile device via a communication module configured to use multiple frequency bands;
defining, with a processor of the vehicle, first and second zones around the vehicle, the second zone being closer to the vehicle than the first zone;
at an interval, estimating, with the processor, a location of the mobile device relative to the vehicle using time-of-flight measurements with a first frequency band when the location is in the first zone and a second frequency band when the location is in the second zone;
between the intervals, tracking the location using dead reckoning; and
controlling the remote parking assist system using the location.

13. The method of claim 12, including defining a third zone around the vehicle, the third zone being closer to the vehicle than the first and second zones.

14. The method of claim 13, including at the interval, estimating, with the processor, the location of the mobile device relative to the vehicle using time-of-flight measurements with a third frequency band when the location is in the third zone.

15. The method of claim 14, wherein the second frequency band includes a higher set of frequencies than the first and third frequency bands.

16. A method comprising:
receiving a mode selection from a mobile device via a communication module configured to communicate with the mobile device using multiple frequency bands;
selecting, with a processor of a vehicle, frequency ranges for a first frequency band and a second frequency band based on the mode selection;
at an interval, estimating a location of the mobile device relative to the vehicle using time-of-flight measurements with the first frequency band when the location is in a first zone and a second frequency band when the location is in a second zone;
between the intervals, tracking the location using dead reckoning; and
controlling a remote parking assist system using the location.

17. The method of claim 16, including defining the first zone, the second zone, and a third zone around the vehicle, the first zone, the second zone, and the third zone not overlapping.

18. The method of claim 16, including:
selecting the frequency ranges for the first frequency band, the second frequency band, and the third frequency band based on the mode selection;
at the interval, estimating the location of the mobile device relative to the vehicle using time-of-flight measurements with the third frequency band when the location the third zone.

19. The method of claim 18, wherein selecting the frequency ranges for the first frequency band, the second frequency band, and the third frequency band includes:
when the mode selection is indicative of a first mode, selecting the frequency ranges so that the second frequency band has a higher set of frequencies than the first and third frequency bands; and
when the mode selection is indicative of a second mode, selecting the frequency ranges so that the third frequency band has a higher set of frequencies than the first and second frequency bands.

20. The method of claim 18, wherein the selectable frequency ranges include a 2.4 GHz frequency band, a 5.0 GHz frequency band, and a 60 GHz frequency band.
